(19) United States
(12) Patent Application Publication
(10) Pub. No.: US 2018/0063933 A1
(43) Pub. Date: Mar. 1, 2018

(54) RADIATION IMAGING APPARATUS, RADIATION IMAGING SYSTEM, AND EXPOSURE CONTROL METHOD

(71) Applicant: CANON KABUSHIKI KAISHA, Tokyo (JP)

(72) Inventors: Hideyuki Okada, Honjo-shi (JP); Toshio Kameshima, Kawasaki-shi (JP); Tomoyuki Yagi, Chofu-shi (JP); Eriko Sato, Tokyo (JP); Takuya Ryu, Kokubunji-shi (JP)

(21) Appl. No.: 15/560,212

(22) PCT Filed: May 23, 2016
(86) PCT No.: PCT/JP2016/002489

§ 371 Date: Sep. 21, 2017

(30) Foreign Application Priority Data
May 26, 2015 (JP) 2015-106729

(51) Int. Cl. H05G 1/38; G01N 23/04; G01T 1/17

(52) U.S. Cl. CPC H05G 1/38; G01T 1/17; G01N 23/04

(57) ABSTRACT

A radiation imaging apparatus includes a pixel array including pixels for detecting radiation and column signal lines, a detector for detecting signals that appear in the column signal lines, and a controller. Each pixel includes a conversion element for converting radiation into an electrical signal and a switch for connecting the conversion element and a column signal line. In a state in which the switches of the pixels irradiated with radiation are open, the detector detects, as a radiation signal, a signal appearing in at least one column signal line. The controller converts an integrated value of the radiation signal into an integrated irradiation amount of radiation. The controller determines, based on the radiation signal and a signal read out by the detector from at least one pixel in a state in which the switch of the at least one pixel of the pixels is closed, a conversion coefficient to convert the integrated value into the integrated irradiation amount.

### TECHNICAL FIELD

The present invention relates to a radiation imaging apparatus, a radiation imaging system, and an exposure control method.

### BACKGROUND ART

There is known a radiation imaging apparatus that electrically captures an optical image formed by radiation such as X-rays. The method of the radiation imaging apparatus can be largely divided into a direct method in which radiation is directly converted into an electrical signal and an indirect method in which radiation is converted into light by a scintillator and the light is converted into an electrical signal. In either method, automatic exposure control is important for stopping radiation emission from the radiation source upon irradiation of the radiation imaging apparatus with an appropriate amount of radiation.

Japanese Patent-Laid Open No. 7-201490 discloses an X-ray diagnosis apparatus that appropriately controls the X-ray exposure amount. In this X-ray diagnosis apparatus, a signal of each X-ray exposure amount detection pixel is read out at predetermined time intervals and integrated by designating an address, and X-ray exposure is stopped when the integrated value exceeds a predetermined value.

Japanese Patent Laid-Open No. 2010-75556 discloses an X-ray exposure amount control apparatus. In this X-ray exposure amount control apparatus, each conversion element that detects X-rays is turned on to continuously operate from the start of X-ray exposure, and the output signals of the conversion element are accumulated. X-ray exposure from the X-ray source is stopped at the point in time when the accumulated value exceeds a threshold.

In a method in which a signal is read out, via a signal line, from the conversion element that detects radiation for automatic exposure control, if the voltage of the conversion element of the imaging pixel changes in accordance with an incident radiation amount, this change can cause the voltage of the signal line to change through capacitive coupling. In addition, the voltage of the signal line can change due to a current leaking from the conversion element of the imaging pixel to the signal line.

Since a plurality of imaging pixels are arrayed in each column, the voltage of a signal line to read out a signal from each corresponding conversion element that detects radiation is influenced by the plurality of imaging pixels. Therefore, it becomes difficult to accurately determine the timing to stop radiation emission from the radiation source by this kind of a method.

### SUMMARY OF INVENTION

The present invention provides a technique advantageous in more accurately determining the timing to stop radiation emission from a radiation source.

One of aspects of the present invention provides a radiation imaging apparatus comprising: a pixel array including a plurality of pixels configured to detect radiation and a plurality of column signal lines; a detector configured to detect signals that appear in the plurality of column signal lines; and a controller, wherein each of the plurality of pixels includes a conversion element configured to convert radiation into an electrical signal and a switch configured to connect the conversion element and a column signal line corresponding to the conversion element out of the plurality of column signal lines, in a state in which the switch of each of the plurality of pixels irradiated with radiation is open, the detector detects, as a radiation signal, a signal appearing in at least one column signal line out of the plurality of column signal lines, and the controller converts an integrated value of the radiation signal into an integrated irradiation amount of radiation, wherein the controller determines, based on the radiation signal and a signal read out by the detector from at least one pixel in a state in which the switch of the at least one pixel of the plurality of pixels is closed, a conversion coefficient to convert the integrated value into the integrated irradiation amount.

Further features of the present invention will become apparent from the following description of exemplary embodiments with reference to the attached drawings.

### BRIEF DESCRIPTION OF DRAWINGS

FIG. 1 is a block diagram showing the arrangement of a radiation imaging system according to first and second embodiments of the present invention;

FIG. 2 is a block diagram showing an example of the arrangement of a radiation detection panel in a radiation imaging apparatus of the radiation imaging system according to the first and second embodiments of the present invention;

FIG. 3 is a schematic view showing an example of the sectional structure of a pixel;

FIG. 4 is a flowchart showing the operation of the radiation imaging system according to the first embodiment of the present invention;

FIG. 5 is a timing chart showing the operation of the radiation imaging system according to the first embodiment of the present invention;

FIG. 6 is a flowchart showing the operation of a comparative example;

FIG. 7 is a timing chart showing the operation of the comparative example;

FIG. 8 is a flowchart showing the operation of the radiation imaging system according to the second embodiment of the present invention;

FIG. 9 is a timing chart showing the operation of the radiation imaging system according to the second embodiment of the present invention; and

FIG. 10 is a timing chart showing another operation of the radiation imaging system according to the second embodiment of the present invention.

### DESCRIPTION OF EMBODIMENTS

Exemplary embodiments of the present invention will be described below with reference to the accompanying drawings.

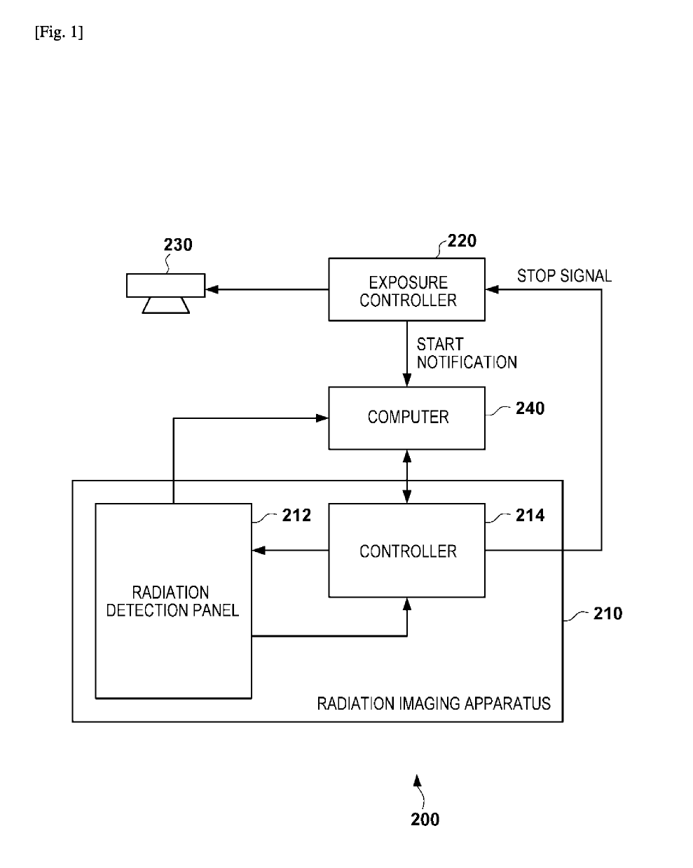

FIG. 1 shows the arrangement of a radiation imaging system 200 according to the first embodiment of the present invention. The radiation imaging system 200 is arranged so as to electrically capture an optical image formed by radiation and obtain an electrical radiation image (that is, radiation image data). The radiation typically can be, for example, X-rays but also may be α-rays, β-rays, or γ-rays. The radiation imaging system 200 can include, for example, a radiation imaging apparatus 210, a radiation source 230, an exposure controller 220, and a computer 240.

The radiation source 230 starts radiation emission in accordance with an exposure instruction (emission instruction) from the exposure controller 220. Radiation emitted from the radiation source 230 passes through an object (not shown) and irradiates the radiation imaging apparatus 210. The radiation source 230 stops emitting radiation in accordance with a stop instruction from the exposure controller 220. The radiation imaging apparatus 210 includes a radiation detection panel 212 and a controller 214 that controls the radiation detection panel 212.

The controller 214 generates a stop signal to stop radiation emission from the radiation source 230 based on a signal obtained from the radiation detection panel 212. The stop signal is supplied to the exposure controller 220, and the exposure controller 220 transmits the stop instruction to the radiation source 230 in response to this stop signal. The controller 214 can be, for example, formed by a PLD (Programmable Logic Device) such as an FPGA (Field Programmable Gate Array), an ASIC (Application Specific Integrated Circuit), a general computer embedded with a program, or a combination of all or some of these components.

The computer 240 controls the radiation imaging apparatus 210 and the exposure controller 220, receives radiation image data from the radiation imaging apparatus 210, and processes the received data. In one example, the exposure controller 220 includes an exposure switch. When the exposure switch is turned on by a user, the exposure controller 220 transmits an exposure instruction to the radiation source 230 and a start notification indicating the start of radiation emission to the computer 240. Upon receiving the start notification, the computer 240 responds to the start notification and notifies the controller 214 of the radiation imaging apparatus 210 about the start of radiation emission.

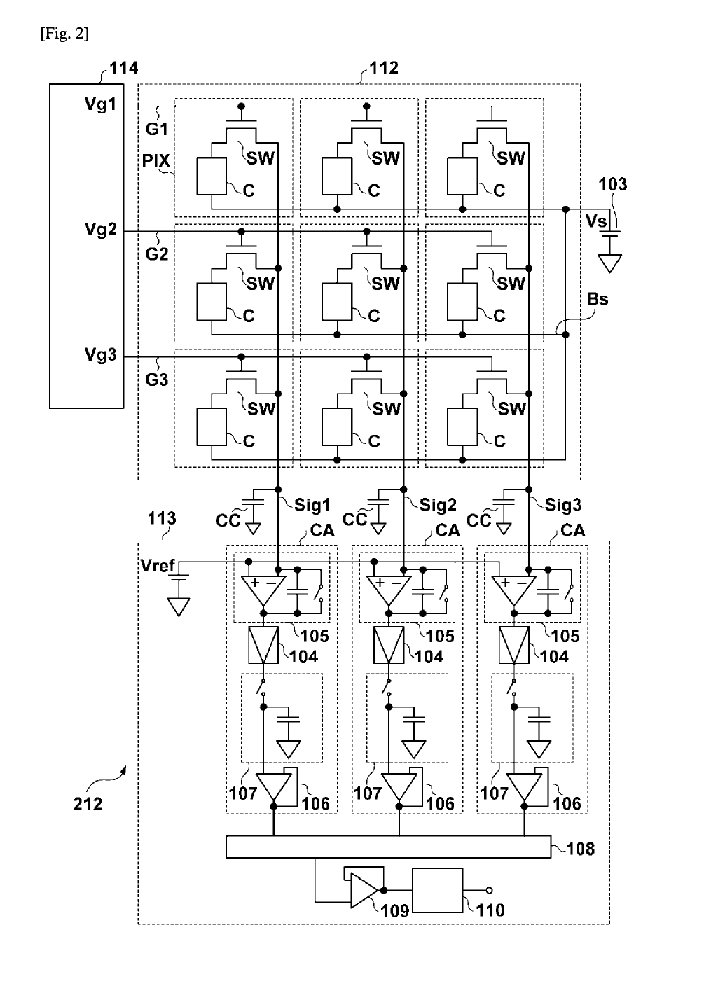

FIG. 2 shows an example of the arrangement of the radiation detection panel 212. The radiation detection panel 212 includes a pixel array 112. The pixel array 112 includes a plurality of pixels PIX that detect radiation and a plurality of signal lines Sig (Sig1 to Sig3). The radiation detection panel 212 also includes a driving circuit (row selection circuit) 114 that drives the pixel array 112 and a detector (readout unit) 113 that detects the signals that appear on the plurality of column signal lines Sig of the pixel array 112. Note that, for the sake of descriptive convenience, the pixel array 112 is constituted by 3 rows×3 columns of pixels PIX in FIG. 2. In practice, however, a larger number of pixels PIX can be arranged. In one example, the radiation detection panel 212 can have a dimension of 17 inches and include approximately 3,000 rows×3,000 columns of pixels PIX.

Each pixel PIX includes a conversion element C that detects radiation and a switch SW that connects the conversion element C and a column signal line Sig (a column signal line Sig corresponding to the conversion element C out of the plurality of column signal lines Sig). The conversion element C outputs a signal corresponding to its incident radiation amount to the signal line Sig. The conversion element C can include, for example, a MIS photodiode mainly made of amorphous silicon and arranged on an insulating substrate such as a glass substrate. Alternatively, the conversion element C can include a PIN photodiode. The conversion element C can be formed as a direct conversion element which directly converts the radiation into an electrical signal or as an indirect conversion element which converts the radiation into light and detects the light. In the case of the indirect conversion element, a scintillator can be shared by the plurality of pixels PIX.

Each switch SW can be formed, for example, from a transistor such as a thin film transistor (TFT) which includes a control terminal (gate) and two main terminals (source and drain). Each conversion element C includes two main electrodes. One main electrode of the conversion element C is connected to one of the two main terminals of the switch SW and the other main electrode of the conversion element C is connected to a bias power source 103 via a common bias line BS. The bias power source 103 generates a bias voltage Vs. The control terminal of the switch SW of each first row pixel PIX is connected to a gate line G1, the control terminal of the switch SW of each second row pixel PIX is connected to a gate line G2, and the control terminal of the switch SW of each third row pixel PIX is connected to a gate line G3. Gate signals Vg1, Vg2, Vg3 . . . are supplied to the gate lines G1, G2, G3 . . . , respectively, by the driving circuit 114.

In each first column pixel PIX, one main terminal of the switch SW is connected to the first column signal line Sig1. In each second column pixel PIX, one main terminal of the switch SW is connected to the second column signal line Sig2. In each third column pixel PIX, one main terminal of the switch SW is connected to the third column signal line Sig3. Each column signal line Sig (Sig1, Sig2, Sig3 . . . ) has a capacitance CC.

The detector 113 includes a plurality of column amplifying units CA so that one column amplifying unit CA corresponds to one column signal line Sig. Each column amplifying unit CA can include, for example, an integration amplifier 105, a variable amplifier 104, a sample and hold circuit 107, and a buffer circuit 106. The integration amplifier 105 amplifies each signal that appears in the corresponding signal line Sig. The integration amplifier 105 can include, for example, an operational amplifier and an integration capacitance and a reset switch connected in parallel between the inverting input terminal and the output terminal of the operational amplifier. A reference voltage Vref is supplied to the non-inverting input terminal of the operational amplifier. The integration capacitance is reset and the voltage of the column signal line Sig is reset to the reference voltage Vref by turning on the reset switch. The reset switch can be controlled by the reset pulse supplied from the controller 214.

The variable amplifier 104 performs amplification by a set amplification factor from the integration amplifier 105. The sample and hold circuit 107 samples and holds the signal from the variable amplifier 104. The sample and hold circuit 107 can be constituted by, for example, a sampling switch and a sampling capacitance. The buffer circuit 106 buffers (impedance-converts) the signal from the sample and hold circuit 107 and outputs the signal. The sampling switch can be controlled by the sampling pulse supplied from the controller 214.

The detector 113 also includes a multiplexer 108 that selects and outputs, in a predetermined order, the signals from the plurality of column amplifying units CA provided so as to correspond with the plurality of column signal lines Sig, respectively. The multiplexer 108 includes, for example, a shift register. The shift register performs a shift operation in accordance with a clock signal supplied from the controller 214 and selects a signal out of the plurality of column amplifying units CA. The detector 113 can also include, for example, a buffer 109 which buffers (impedance-converts) the signal output from the multiplexer 108 and an AD converter 110 which converts an analog signal, as the output signal from the buffer 109, into a digital signal. The output of the AD converter 110, that is, the radiation image data is supplied to the computer 240.

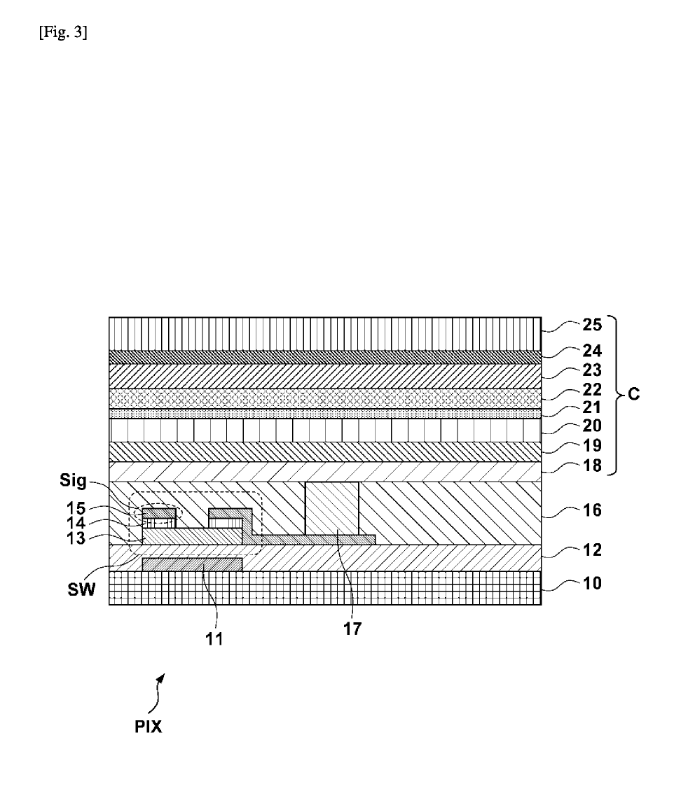

FIG. 3 schematically shows an example of the sectional structure of one pixel PIX. The example shown in FIG. 3 will be described below. The pixel PIX is formed on an insulating substrate 10 such as a glass substrate or the like. The pixel PIX includes, on the insulating substrate 10, a first electrically conductive layer 11, a first insulating layer 12, a first semiconductor layer 13, a first impurity semiconductor layer 14, and a second electrically conductive layer 15. The first electrically conductive layer 11 forms the gate of a transistor (for example, a TFT) which forms the switch SW. The first insulating layer 12 is arranged to cover the first electrically conductive layer 11, and the first semiconductor layer 13 is arranged on the first insulating layer 12 above the portion forming the gate out of the first electrically conductive layer 11. The first impurity semiconductor layer 14 is arranged on the first semiconductor layer 13 so as to form the two main terminals (source and drain) of the transistor forming the switch SW. The second electrically conductive layer 15 forms the wiring line pattern connected to each of the two main terminals (source and drain) of the transistor forming the switch SW. A part of the second electrically conductive layer 15 forms the column signal line Sig and the remaining part forms the wiring line pattern to connect with the switch SW of the conversion element C.

The pixel PIX further includes an interlayer insulating film 16 that covers the first insulating layer 12 and the second electrically conductive layer 15. The interlayer insulating film 16 is provided with a contact plug 17 which connects with the second electrically conductive layer 15 (switch SW). The pixel PIX further includes the conversion element C arranged on the interlayer insulating film 16. In the example shown in FIG. 3, the conversion element C is formed as an indirect conversion element which includes a scintillator layer 25 for converting the radiation into light. The conversion element C includes a third electrically conductive layer 18, a second insulating layer 19, a second semiconductor layer 20, a second impurity semiconductor layer 21, a fourth electrically conductive layer 22, a protection layer 23, an adhesion layer 24, and the scintillator layer 25 stacked, in this order, on the interlayer insulating film 16. The third electrically conductive layer 18, the second insulating layer 19, the second semiconductor layer 20, the second impurity semiconductor layer 21, the fourth electrically conductive layer 22, the protection layer 23, the adhesion layer 24, and the scintillator layer 25 form the conversion element C.

The third electrically conductive layer 18 and the fourth electrically conductive layer 22 form the lower electrode and the upper electrode, respectively, of the photoelectric conversion element that forms the conversion element C. The fourth electrically conductive layer 22 is formed of, for example, a transparent material. The third electrically conductive layer 18, the second insulating layer 19, the second semiconductor layer 20, the second impurity semiconductor layer 21, and the fourth electrically conductive layer 22 form a MIS sensor serving as the photoelectric conversion element. The second impurity semiconductor layer 21 is formed of, for example, an n-type impurity semiconductor layer. The scintillator layer 25 can be formed of, for example, a gadolinium-based material or CsI (cesium iodide) material.

The conversion element C can be formed as a direct conversion element that directly converts incident radiation into an electrical signal (charges). The direct conversion element C can be a conversion element using amorphous selenium, gallium arsenide, gallium phosphide, lead iodide, mercury iodide, CdTe, CdZnTe, or the like as its main material. The conversion element C is not limited to a MIS conversion element and can be, for example, a pn or PIN photodiode.

In the example shown in FIG. 3, the plurality of column signal lines Sig overlap parts of the plurality of pixels PIX, respectively, upon orthographic projection on the surface on which the pixel array 112 is formed. Although this kind of an arrangement is advantageous in increasing the area of the conversion element C in each pixel PIX, it is disadvantageous, on the other hand, in that capacitive coupling will increase between each conversion element C and the corresponding column signal line Sig. When the radiation enters the conversion element C and the voltage of the third electrically conductive layer 18 serving as the lower electrode changes from the accumulation of charges in the conversion element C, the voltage of the corresponding column signal line Sig also changes due to capacitive coupling between the conversion element C and the corresponding column signal line Sig.

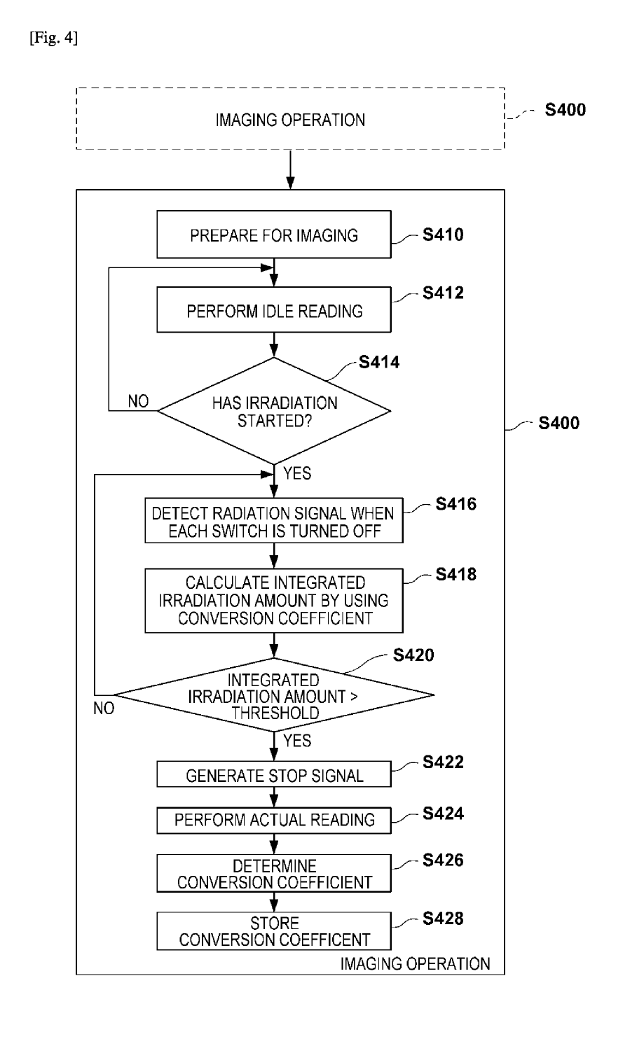

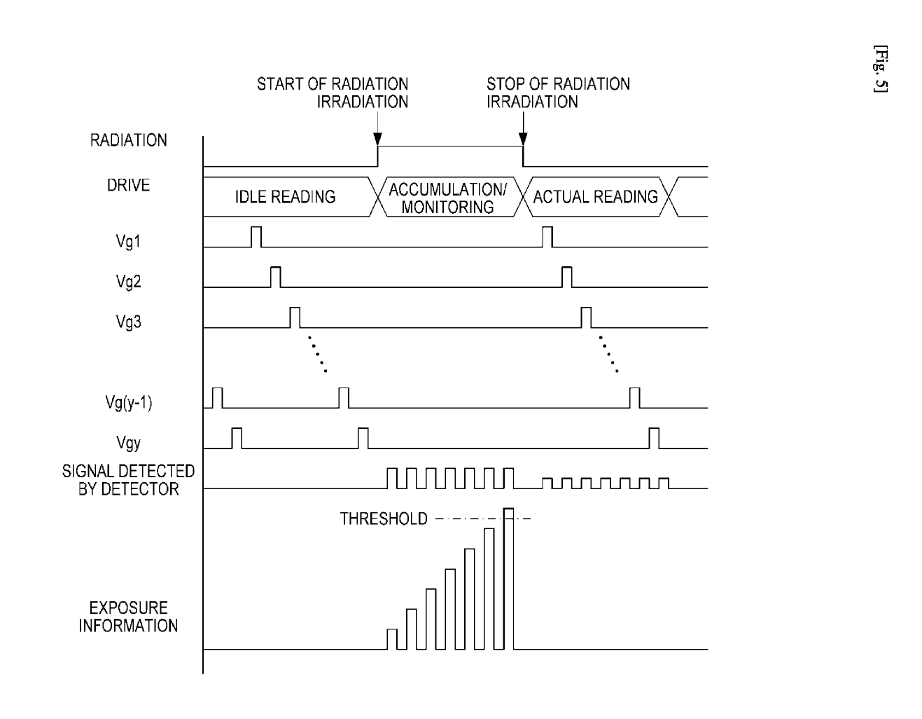

The operation of the radiation imaging apparatus 210 and the radiation imaging system 200 will be described below with reference to FIGS. 4 and 5. The operation of the radiation imaging system 200 is controlled by the computer 240. The operation of the radiation imaging apparatus 210 is controlled by the controller 214 under the control of the computer 240.

In one example, an imaging operation S400 can be executed repeatedly. One imaging operation S400 will be described below. First, in step S410, preparations are made for imaging. Preparations for imaging can include, for example, setting the radiation irradiation conditions, setting exposure information and a region of interest to control the exposure, and the like. These can be set by a user using an input device of the computer 240. The exposure information setting can be the target exposure amount setting in one region of interest. Alternatively, the exposure information setting can be the average value or the maximum value of the exposure amounts of the plurality of regions of interest. The setting of the exposure information can also be the ratio or the difference between the minimum value and the maximum value of the exposure amounts of the plurality of regions of interest. A threshold to determine the timing for the controller 214 to cause the radiation source 230 to stop the radiation emission is determined in accordance with the setting of the exposure information.

In steps S412 and S414, the controller 214 causes the driving circuit 114 and the detector 113 to perform idle reading until radiation emission from the radiation source 230 (in other words, radiation irradiation to the radiation imaging apparatus 210) is started. More specifically, in step S412, for example, idle reading is performed on one or a plurality of rows, and in step S414, it is determined whether radiation emission from the radiation source 230 has been started. If it is determined that radiation emission has been started, idle reading is ended and the process advances to step S416. If it is determined that radiation emission has not been started, the process returns to step S412. Initial reading is an operation in which the driving circuit 114 sequentially drives the gate signals Vg1, Vg2, Vg3 . . . Vgy supplied to the gate signals G1, G2, G3 . . . Gy, respectively, of the plurality of rows of the pixel array 112 to an active level and resets the dark charges accumulated in the conversion element C. Upon idle reading, an active level reset pulse is supplied to the reset switch of each integration amplifier 105 and the corresponding column signal line Sig is reset to the reference voltage. Dark charges are charges that are generated even without radiation entering the conversion element C.

The controller 214 can recognize the start of radiation emission from the radiation source 230 based on the start notification supplied from, for example, the exposure controller 220 via the computer 240. Alternatively, a detection circuit for detecting a current flowing in the bias line Bs or in each column signal line Sig of the pixel array 112 can be provided. The controller 214 can recognize the start of radiation emission from the radiation source 230 based on the output from the detection circuit.

In step S416, the detector 113 detects, in a state in which the switch SW of each of the plurality of pixels PIX irradiated with radiation and forming the pixel array 112 is open, a signal that appears on at least one column signal line Sig out of the plurality of column signal lines Sig as a radiation signal. In this case, a state in which the switch SW is open is equivalent to a state in which the switch SW is OFF. The column signal line Sig which is to detect each signal is a column signal line running through the set region of interest. Even if the switch SW of each pixel PIX is open, the voltage of each corresponding column signal line Sig can change, due to the aforementioned capacitive coupling, in accordance with the voltage change of the lower electrode of the conversion element C of each pixel PIX. Additionally, even in a state in which the switch SW of each pixel PIX is open, if the switch SW is not completely turned off, some small amount of leak current can flow through the switch SW and change the voltage of the corresponding column signal line Sig.

In other words, the radiation signal can include a component that appears in at least one column signal line Sig due to capacitive coupling of the at least one column signal line Sig serving as a radiation signal detection target out of the plurality of radiation signals Sig and the adjacent pixels PIX. Alternatively, the radiation signal can include a component due to the leak current to at least one column signal Sig from the pixels PIX adjacent to the at least one column signal line Sig serving as the radiation signal detection target out of the plurality of column signal lines Sig. In this case, assume that each pixel PIX adjacent to one column signal line Sig is typically a pixel PIX whose conversion element C is connected, via the switch SW, to a corresponding column signal line Sig out of the plurality of pixels PIX forming the pixel array 112.

In step S418, the controller 214 calculates an integrated irradiation amount ID by using a preset conversion coefficient CF. More specifically, for example, the controller 214 calculates the integrated irradiation amount ID by multiplying an integrated value which has integrated the radiation signals detected in step S416 by the conversion coefficient CF. The integration of the radiation signals is performed by adding the value of the latest radiation signal RI detected in step S416 to an integrated value IV (that is, calculating IV=IV+RI) each time step S418 is executed. The integrated irradiation amount ID can be obtained by multiplying the integrated value IV by the conversion coefficient CF (that is, calculating ID=IV×CF).

The conversion coefficient CF may be preset by an experiment or a simulation. It also may be determined based on an imaging result from an imaging operation S400 that has been executed in the past.

In step S420, the controller 214 determines whether the integrated irradiation amount ID exceeds the threshold. If the integrated irradiation amount ID exceeds the threshold, the controller 214 generates the stop signal to stop radiation emission from the radiation source 230. In response to the generation of this stop signal, the exposure controller 220 transmits the stop instruction to the radiation source 230 and the radiation source 230 stops the radiation emission according to the stop instruction. Hence, the exposure amount is controlled appropriately.

In step S424, the controller 214 causes the driving circuit 114 and the detector 113 to execute actual reading. In the actual reading, the driving circuit 114 sequentially drives the gate signals Vg1, Vg2, Vg3 . . . Vgy to be supplied to the gate signals G1, G2, G3 . . . Gy, respectively, of the plurality of rows of the pixel array 112 to an active level. Then, the detector 113 reads out the charges accumulated in the conversion elements C via the plurality of column signal lines Sig and outputs the readout charges as radiation image data to the computer 240 via the multiplexer 108, the buffer 109, and the AD converter 110.

In step S426, the controller 214 determines the conversion coefficient CF based on the integrated value IV calculated in step S418 and at least one piece of pixel data of the radiation image data read out in step S424 (a signal read out from at least one of the plurality of pixels). More specifically, letting PD be the value of pixel data of a given region of interest, the conversion coefficient CF can be determined, for example, in accordance with CF=PD/IV.

In step S428, the controller 214 stores the conversion coefficient CF determined in step S426. This conversion coefficient CF can be used in step S418 of an imaging operation S400 to be performed subsequently.

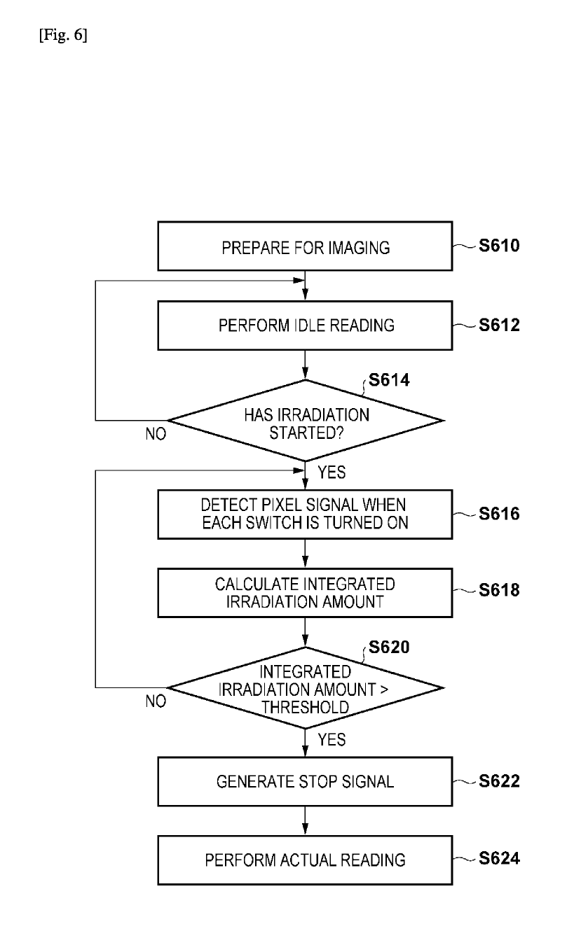

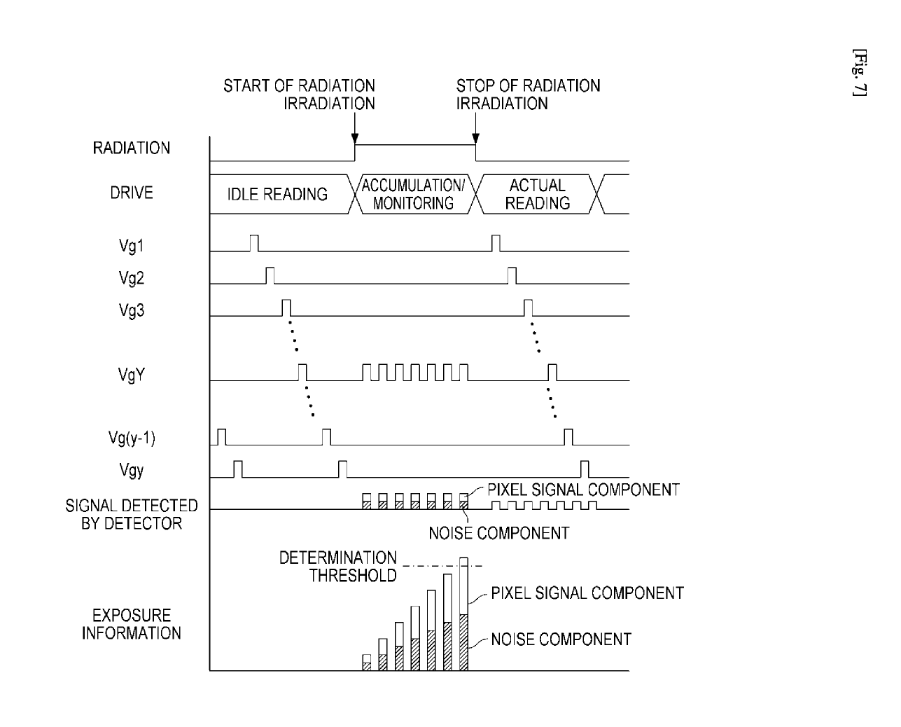

A comparative example will be described next with reference to FIGS. 6 and 7 to clarify the usefulness of the radiation imaging system according to the first embodiment in comparison with the comparative example. First, in step S610, imaging preparations are made. This process is the same as that of the aforementioned step S410.

In steps S612 and S614, the controller 214 causes the driving circuit 114 and the detector 113 to perform idle reading until radiation emission from the radiation source 230 (in other words, radiation irradiation to the radiation imaging apparatus 210) is started. These processes are the same as those in the aforementioned steps S412 and S414.

In step S616, the detector 113 detects, in a state in which the switch SW of each pixel of a specific row (to be referred to as the Yth row hereinafter) out of the plurality of pixels PIX irradiated with radiation and forming the pixel array 112 is closed, the signal which appears in at least one column signal line Sig out of the plurality of signal lines Sig is detected as the irradiation amount signal. In this case, a state in which the switch SW is closed is equivalent to a state in which the switch SW is ON. The column signal line Sig which is to detect a signal is the column signal line Sig running through a set region of interest.

In a state in which the switch SW of each pixel PIX of the Yth row is closed, charges accumulated in the conversion element C of each pixel PIX of the Yth row are transferred to each corresponding one of the plurality of column signal lines Sig and each signal corresponding to the charges (to be referred to as a pixel signal component hereinafter) is read out by the detector 113. The signal read out by the detector 113 can include, other than the pixel signal component, a noise component due to the afore-mentioned capacitive coupling, that is, a noise component caused by a voltage change in the column signal Sig due to voltage changes in the lower electrodes of the conversion elements C of pixels PIX of rows other than the Yth row. In addition, the signal read out by the detector 113 can include a noise component due to a leak current flowing through the column signal Sig via each switch SW in a structure in which the switch SW of each pixel PIX of rows other than the Yth row cannot be completely turned off.

In step S618, the controller 214 calculates the integrated irradiation amount by integrating the irradiation amount signals detected in step S616. The integration of the irradiation amount signal can be performed by adding the value of the latest irradiation signal IA detected in step S616 to the integrated irradiation amount ID (that is, calculating ID=ID+IA) each time step S618 is executed.

In step S620, the controller 214 determines whether the integrated irradiation amount ID exceeds the threshold. If the integrated irradiation amount ID exceeds the threshold, the controller 214 generates the stop signal to stop radiation emission from the radiation source 230. In step S624, the controller 214 causes the driving circuit 114 and the detector 113 to perform actual reading.

In one example, the ratio (noise component/pixel signal component) of the noise component from one pixel to the pixel signal component of one pixel included in a signal read out in step S616 is about 1/50. In a case in which there are 3,000 rows forming the pixel array, the ratio of the noise components from pixels of other rows to the pixel signal component from one pixel becomes 1/50×2,999=about 60. That is, the S/N ratio becomes about 1/60. In addition, the S/N ratio can become smaller since the radiation that has passed through an object will enter the region of interest.

On the other hand, the noise component generated by each pixel PIX is proportional to the intensity of the radiation that has entered the pixel PIX, and the integrated value of the noise component generated by the pixel is proportional to the integrated value of the intensity of the radiation that entered this pixel.

Hence, in the first embodiment of the present invention, a signal which becomes a noise component in the comparative example is used as a signal useful for evaluating the irradiation amount of radiation to the radiation imaging apparatus. That is, in the first embodiment of the present invention, in a state in which the switch SW of each of a plurality of pixels PIX irradiated with radiation is open (OFF), the detector 113 detects, as a radiation signal, a signal which appears in at least one column signal line Sig out of the plurality of column signal lines Sig. Then, the controller 214 generates the stop signal to cause the radiation source 230 to stop radiation emission based on the integrated value of the radiation signal. In one example, the controller 214 can generate a stop signal based on the radiation irradiation amount converted from the integrated value of the radiation signal.

The waveform of radiation intensity does not become an ideal rectangular pulse in accordance with the setting values of the tube voltage and the tube current or the type or state of the tube. In most cases, it becomes a ringing or dull waveform. Furthermore, since the conversion from radiation to light in the scintillator can become delayed in an indirect radiation imaging apparatus, the waveform of the light intensity detected by the photoelectric conversion element dulls larger. An exposure control error easily occurs in a case in which the radiation stop timing is determined by a small readout count at a time when there are large changes in the radiation intensity. On the contrary, if the readout count is increased, the S/N ratio can decrease because charges contributing to a single readout are reduced.

In contrast, according to the first embodiment of the present invention, in a state in which the switch SW of each of the plurality of pixels PIX adjacent to a column line Sig is open, each signal that appears in the column signal line Sig due to the influence from the plurality of pixels PIX is detected as a radiation signal. Therefore, since S/N ratio reduction can be suppressed even if the exposure control readout count (detection count) is increased, the exposure can be controlled with high accuracy even in a case in which the waveform of radiation intensity is distorted.

Furthermore, according to the first embodiment of the present invention, since the switch SW of each pixel PIX is not closed until actual reading starts, no charges of the pixel PIX are lost. That is, a radiation image without a loss arising from exposure control can be obtained.

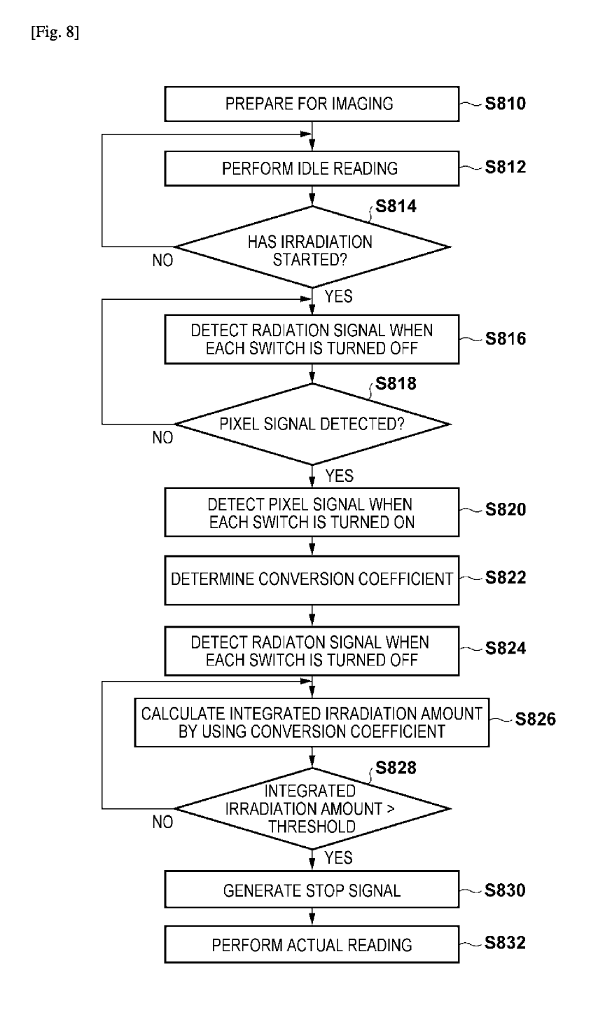

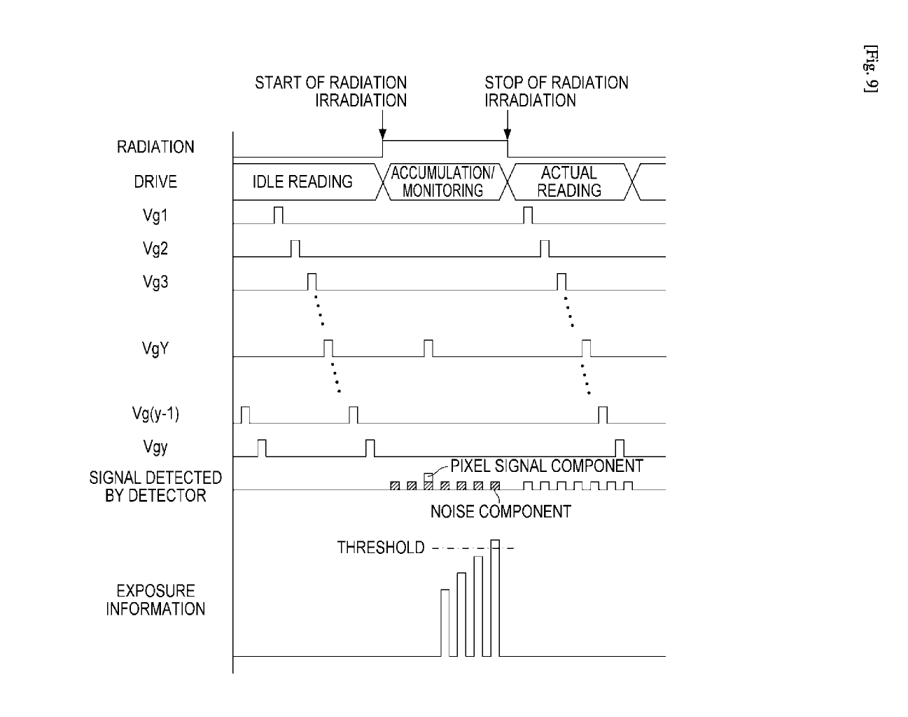

A radiation imaging apparatus and a system according to the second embodiment of the present invention will be described next with reference to FIGS. 8 and 9. Note that matters not mentioned in the second embodiment can follow the first embodiment. In the second embodiment, a conversion coefficient is determined based on information obtained from closing a switch SW of each pixel PIX during radiation irradiation.

Processes of steps S810, S812, S814, S824, S826, S828, S830, and S832 in FIG. 8 are the same as those of steps S410, S412, S414, S416, S418, S420, S422, and S424 in FIG. 4.

In step S816, in a state in which the switch SW of each of the plurality of pixels PIX irradiated with radiation and forming a pixel array 112 is open, a detector 113 detects, as a radiation signal, a signal that appears in at least one column signal line Sig out of the plurality of signal lines Sig.

In step S818, a controller 214 evaluates the change of the radiation signal (that is, the difference between the preceding radiation signal and the latest radiation signal) based on the radiation signal detected in step S816. Then, upon determining that the change of the radiation signal is equal to or less than a predetermined value, the controller 214 advances the process to step S820.

In step S820, the controller 214 closes the switch SW of each pixel of a specific row (to be referred to as the Yth row hereinafter) of the plurality of pixels PIX that form the pixel array 112 and causes the detector 113 to read out the signal of each pixel PIX of the Yth row as the first signal in this state. That is, in step S820, the detector 113 reads out, in a state in which the switch SW of at least one pixel PIX of the plurality of pixels PIX irradiated with radiation and forming the pixel array 112 is closed, the signal of the at least one pixel PIX as the first signal. The processes of steps S818 and S820 are intended for reading out the first signal based on the change in radiation intensity. More specifically, the processes of steps S818 and S820 are intended to read out the first signal at the timing when the change in radiation intensity has settled. In other words, the timing when the switch SW of at least one pixel PIX out of the plurality of pixels PIX forming the pixel array 112 is closed to detect the first signal is determined based on the change in the radiation signal.

Each pixel PIX of the Yth row can be a pixel dedicated to exposure control or a pixel also used to perform imaging. Alternatively, the Yth row can include the pixel for exposure control and the pixel for imaging and the pixels may be controlled via separate gate lines.

In step S822, the controller 214 determines a conversion coefficient CF based on the first signal read out in step S820 and a second signal which is a radiation signal detected immediately before (that is, the preceding step S816) the readout of the first signal. In this case, the second signal can be detected by the detector 113 immediately after the readout of the first signal.

The first signal includes, other than the aforementioned pixel signal component, a noise component due to capacitive coupling and/or a leak current. The second signal is a noise component due to capacitive coupling and/or a leak current. For example, the controller 214 can calculate, as the conversion coefficient CF, a value obtained by dividing the difference between the first signal and the second signal with the second signal. This conversion coefficient CF is used to calculate an integrated irradiation amount in step S824 after detecting the radiation signal in step S824.

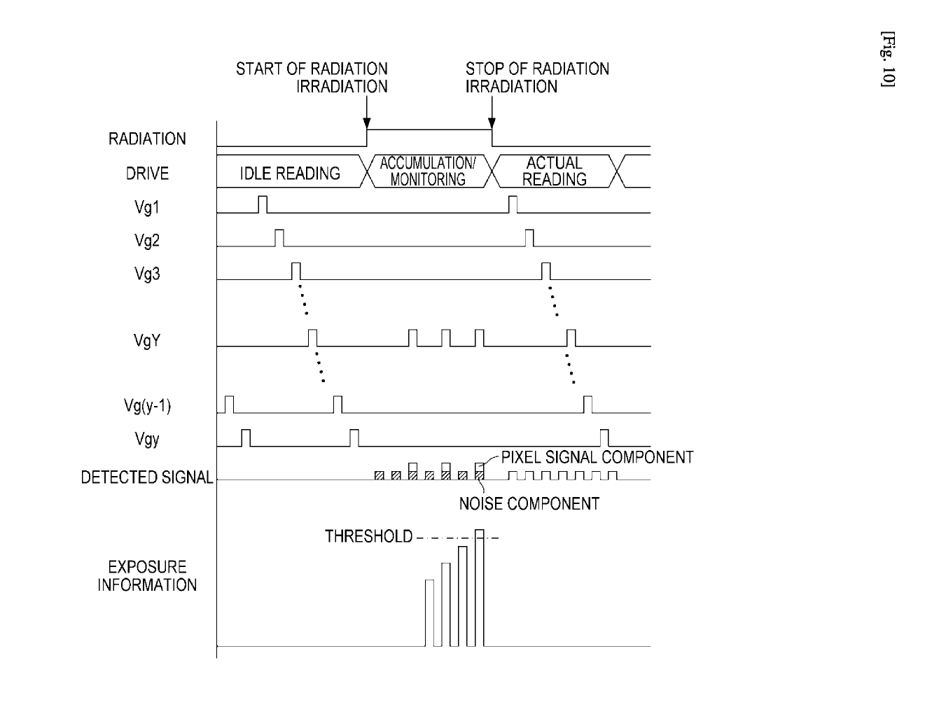

The detection of the first signal in step S820 can be performed over a plurality of times as exemplified in FIG. 10. Each time the first signal is newly detected, the conversion coefficient CF can be updated based on the newly detected first signal. Alternatively, the conversion coefficient CF can be calculated based on an average of the plurality of first signals or the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-106729, filed May 26, 2015, which is hereby incorporated by reference herein in its entirety.

1. A radiation imaging apparatus comprising:
a pixel array including a plurality of pixels configured to detect radiation and a plurality of column signal lines;
a detector configured to detect signals that appear in the plurality of column signal lines; and
a controller,
wherein each of the plurality of pixels includes a conversion element configured to convert radiation into an electrical signal and a switch configured to connect the conversion element and a column signal line corresponding to the conversion element out of the plurality of column signal lines,
in a state in which the switch of each of the plurality of pixels irradiated with radiation is open, the detector detects, as a radiation signal, a signal appearing in at least one column signal line out of the plurality of column signal lines, and
the controller converts an integrated value of the radiation signal into an integrated irradiation amount of radiation,
wherein the controller determines, based on the radiation signal and a signal read out by the detector from at least one pixel in a state in which the switch of the at least one pixel of the plurality of pixels is closed, a conversion coefficient to convert the integrated value into the integrated irradiation amount.

2. The apparatus according to claim 1, wherein the controller generates, based on the integrated irradiation amount of radiation converted from the integrated value of the radiation signal, a stop signal to stop radiation emission from a radiation source.

3. The apparatus according to claim 1, wherein the detector is configured to read out signals from the plurality of pixels of the pixel array after radiation emission is stopped, and
the conversion coefficient is determined based on the radiation signal detected at the time of previously executed imaging and a signal read out from at least one of the plurality of pixels of the pixel array by the detector at the time of imaging.

4. The apparatus according to claim 1, wherein in a state in which the switch of at least one pixel of the plurality of pixels irradiated with radiation is closed, the detector reads out, as a first signal, a signal of the at least one pixel, and
the conversion coefficient is determined based on the first signal and a second signal which is the radiation signal detected immediately before or immediately after the readout of the first signal.

5. The apparatus according to claim 4, wherein the conversion coefficient has a value obtained by dividing a difference between the first signal and the second signal by the second signal.

6. The apparatus according to claim 4, wherein the detector reads out the first signal over a plurality of times during radiation irradiation, and the conversion coefficient is determined based on a plurality of first signals.

7. The apparatus according to claim 4, wherein a timing to close the switch of the at least one pixel to detect the first signal is determined based on a change in the radiation signal.

8. The apparatus according to claim 1, wherein in an orthographic projection on a surface on which the pixel array is formed, the plurality of column signal lines overlap parts of the plurality of pixels, respectively.

9. The apparatus according to claim 1, wherein the radiation signal includes a component that appears in at least one column signal line due to capacitive coupling of the at least one column signal line and some of the plurality of pixels.

10. The apparatus according to claim 1, wherein the radiation signal includes a component caused by a leak current from some of the plurality of pixels to the at least one column signal line.

11. A radiation imaging system comprising:
a radiation imaging apparatus;
a radiation source; and
an exposure controller configured to start radiation emission from the radiation source and stop radiation emission from the radiation source in response to a stop signal from the radiation imaging apparatus,
wherein the radiation imaging apparatus comprises:
a pixel array including a plurality of pixels configured to detect radiation and a plurality of column signal lines;
a detector configured to detect signals that appear in the plurality of column signal lines; and
a controller,
wherein each of the plurality of pixels includes a conversion element configured to convert radiation into an electrical signal and a switch configured to connect the conversion element and a column signal line corresponding to the conversion element out of the plurality of column signal lines,
in a state in which the switch of each of the plurality of pixels irradiated with radiation is open, the detector detects, as a radiation signal, a signal appearing in at least one column signal line out of the plurality of column signal lines, and
the controller converts an integrated value of the radiation signal into an integrated irradiation amount of radiation,
wherein the controller determines, based on the radiation signal and a signal read out by the detector from at least one pixel in a state in which the switch of the at least one pixel of the plurality of pixels is closed, a conversion coefficient to convert the integrated value into the integrated irradiation amount.

12. An exposure control method of a radiation imaging system that includes a pixel array including a plurality of pixels configured to detect radiation and a plurality of column signal lines, and a detector configured to detect signals that appear in the plurality of column signal lines, wherein each of the plurality of pixels includes a conversion element configured to detect radiation and a switch configured to connect the conversion element and a column signal line corresponding to the conversion element out of the plurality of column signal lines, comprising:
in a state in which the switch of each of the plurality of pixels irradiated with radiation is open, detecting, by the detector, as a radiation signal, a signal appearing in at least one column signal line out of the plurality of column signal lines,
generating, based on an integrated irradiation amount of radiation converted from an integrated value of the radiation signal, a stop signal to stop radiation emission from a radiation source, and
determining, based on the radiation signal and a signal read out by the detector from at least one pixel in a state in which the switch of the at least one pixel of the plurality of pixels is closed, a conversion coefficient to convert the integrated value into the integrated irradiation amount.
